(19) United States
(12) Patent Application Publication
(10) Pub. No.: US 2012/0154119 A1
(43) Pub. Date: Jun. 21, 2012

(54) INTERACTIVE PERSONAL PROPERTY LOCATION SYSTEM

(76) Inventor: Michael Lee Schepps, Portland, OR (US)

(21) Appl. No.: 12/973,724

(22) Filed: Dec. 20, 2010

(51) Int. Cl. H04Q 5/22; H04W 88/02

(52) U.S. Cl. 340/10.1; 340/326; 455/575.1

(57) ABSTRACT

A redundant system of interactive alert devices designed to be attached to a cell phone, a wallet and a set of keys. Any one of these devices can initiate a signal to enable the other two to activate a visual, vibratory and or audible signal so they can be located. The cell phone case incorporates a secondary DC power source that must be manually manipulated when the cell phone is uncoupled from the case to be utilized, thereby allowing the user an extended period to make an emergency call in the event the phone is dead.

### BACKGROUND OF THE INVENTION

The present invention relates to a new and improved interactive personal property location system adapted to provide convenience for location of three of the most commonly misplaced or lost items of personal property—a wallet, a set of keys and a cell phone.

Heretofore, when a set of keys, a wallet or one's cell phone was missing, the owner generally had to scour the immediate vicinity or retrace his preceding steps in order to find the lost property. When personal property as important as these three items are lost, it causes the owners a great amount of stress, especially in light of today's increased levels of identity theft.

While some personal property devices such as remote controls have audible alarming systems, these don't work well for the elderly or those with impaired hearing. Additionally, such items with built-in audible locators are stand alone systems and the method of activating their alert (generally by whistling or clapping) may be extremely limited in range.

Henceforth, an interactive personal property location system that would work over an extended range through the creation of an RFID enabled system, protect wallets, cell phones and keys and provide more than an audible signal would fulfill a long felt need for those who frequently misplace smaller items of personal property that are involved in critical day to day functions. For people with mild dementia or early onset Alzheimer's disease, this invention is a necessity. This new invention utilizes and combines known and new technologies in a unique and novel configuration to overcome the aforementioned problems and accomplish this.

### SUMMARY OF THE INVENTION

The general purpose of the present invention, which will be described subsequently in greater detail, is to provide a redundant system for the simplified retrieval of common items of personal property. In addition, the improved interactive personal property location system provides for emergency cell phone operation once the cell phone's battery has died. The system is comprised of three elements: a key fob, an alert card and a cell phone case.

It has many of the advantages mentioned heretofore and many novel features that result in a new and improved interactive personal property location system which is not anticipated, rendered obvious, suggested, or even implied by any of the prior art, either alone or in any combination thereof.

In accordance with the invention, an object of the present invention is to provide an improved interactive personal property location system capable of aiding in the retrieval of one's keys, wallet or cell phone when still in the possession of at least one of these items with or without the use of an incorporated RFID system.

It is another object of this invention to provide an improved interactive personal property location system capable of providing an audible, vibratory and visual notification of misplaced items of personal property.

It is a further object of this invention to provide an improved interactive personal property location system with an emergency cell phone operational capability. It is still a further object of this invention to provide for a method of locating one's lost cell phone when the original battery is dead.

It is yet a further object of this invention to provide a redundant method for the retrieval of lost personal property.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a front perspective view of the interactive personal property location system showing the general arrangement of the three components;

FIG. 2 is a front perspective view of the cell phone alert case with the cell phone removed;

FIG. 3 is a back perspective view of the cell phone alert case;

FIG. 4 is a side cross sectional view of the cell phone alert case;

FIG. 5 is a front view of the alert credit cart showing the general electrical layout;

FIG. 6 is a front view of the alert key fob with the cover removed showing the general electrical layout; and

FIG. 7 is a front perspective view of the interactive personal property location system showing the general arrangement of the three components with the cell phone removed from its alert case.

### DETAILED DESCRIPTION

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. For example, although throughout the alert fob is associated with a key ring and the alert card is associated with the wallet, it is known that these alert devices may be physically connected to other items such as an MP3 player, an article of clothing, a camera, etc. Also, it is to be understood that the phraseology and terminology employed herein are for the purpose of descriptions and should not be regarded as limiting.

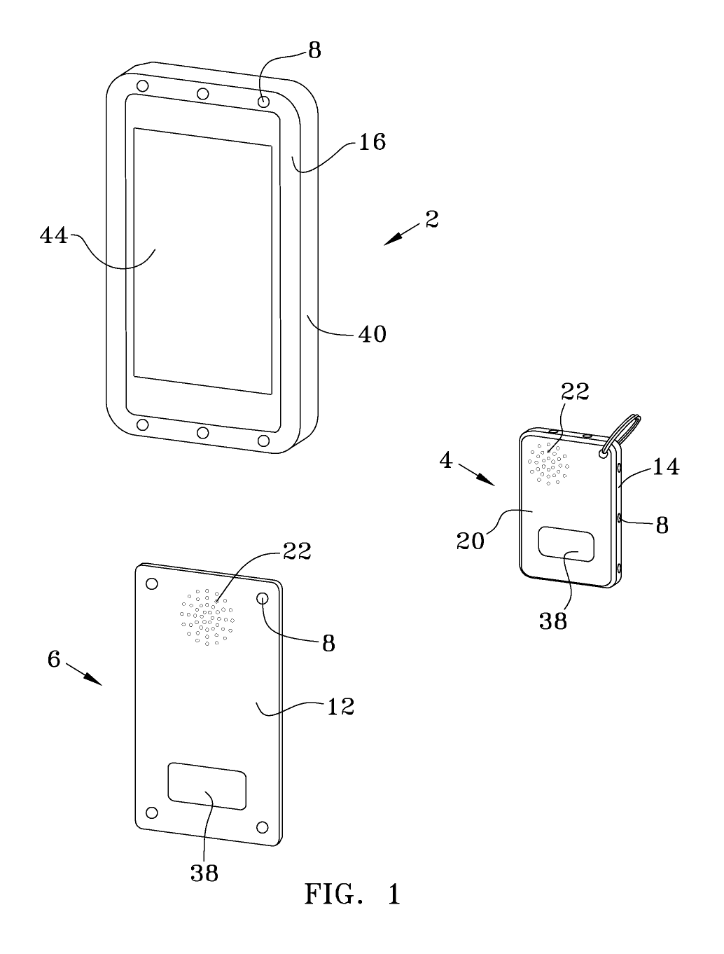

Looking at FIG. 1 it can be seen that the interactive personal property location system has a cell phone alert case 2, an alert key fob 4 and an alert credit card 6. Each alert component has multiple light emitting diodes (LEDS) 8 fixed about their perimeter and an internal radio frequency identification chip 50 (RFID.) The light emitting diodes may be on the front face and/or back face and/or the side of their respective bodies. On the alert credit card 6 there are four LEDS shown on the card front face 12, on the alert key fob 4 there are ten LEDS shown on the side 14 and on the cell phone alert case 2 there are six LEDS shown on the case front face 16 and six LEDS on the case back face 24 (FIG. 3) although it is known that these represent only some of the possible combinations of location of these lights on the alert components bodies. Each alert component also has a thin profile audible and vibratory alert means 10. Such thin profile devices in the preferred embodiment are piezoelectric. In all of the alert components the audible and vibratory means 10 is located behind the front or back face of the component. In the alert credit card 6 it resides behind perforations 22 in the card front face 12 and in the alert key fob 4 it resides behind the perforations 22 in the fob front face 20 while in the cell phone alert case 2 it resides behind the perforations 22 in the case back face 24. (FIG. 3)

Each device has an alert button 38 that upon a first depression, activates that device's microprocessor 34 to operate that device's alert transponder 36 to transmit a wireless alert signal over a limited range. (The initial alert activation.) The microprocessor also inhibits the auditory, vibratory and visual alerts on that device from activating. The transponders 36 of the other alert devices, if in signal range, will receive the wireless alert signal and the microprocessor 34 coupled to the transponder 36 will initiate a flow of current to activate the auditory and vibratory means 10 and the LEDS 8 on the other two alert components. The microprocessor incorporates the necessary power switching components to route the flow of power as is well known in the art. With the LEDS on and flashing, the vibratory means causing the alert component to vibrate, and the auditory means sounding a loud alert, the misplaced component should be easily located. In the event that the misplaced devices are out of signal range, the owner may walk around the area with the alert device that the initial alert activation was made on to increase the operational signal range. Subsequent depression of any alert button 38 on any alert device will send another wireless signal to cancel the first alert signal such that all the auditory and vibratory means 10 and the LEDS 8 will rest. As is well known in the art, there are various different configurations of the system logic that will accommodate this type of operation. The RFID chip 50 in each of the devices, imparts the ability for electronic recognition (communication by/with other electronic devices) regarding the location and identification of the devices. This will help in third party tracking of the devices (as in the case of stolen/misplaced items) or the persons with those devices on them (such as a lost or confused Alzheimer's patient.) The power to the RFID chip also derives from the coin cell batteries.

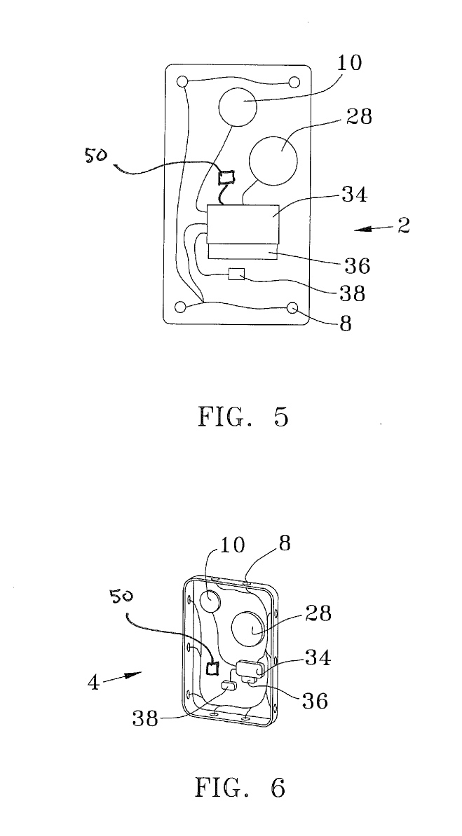

The physical configuration of the alert credit card 6 may be longer than a conventional credit card such that when inserted into a wallet, it's auditory and vibratory means and LEDS will extend beyond the outside of the top of the wallet. If a conventional size alert credit card is desired, a careful trimming of the card with a pair of scissors will accomplish this. Looking at FIG. 5 the internal components of the alert credit card can best be seen. Although the electrical pathways have been designated as wires in all of the alert components, it is known that printed circuit boards with etched copper traces would be used in a preferred embodiment.

The alert key fob 4 resembles the conventional small key fob that many car manufacturers use to control limited functions on their vehicles. The microprocessor 34 in conjunction with the transponder 36 may be programmed to replace the existing vehicle's key fob. Such programming is well known in the art and is commonly done with such devices as tv/dvd/vcr/garage door remote controls in a “head to head” fashion.

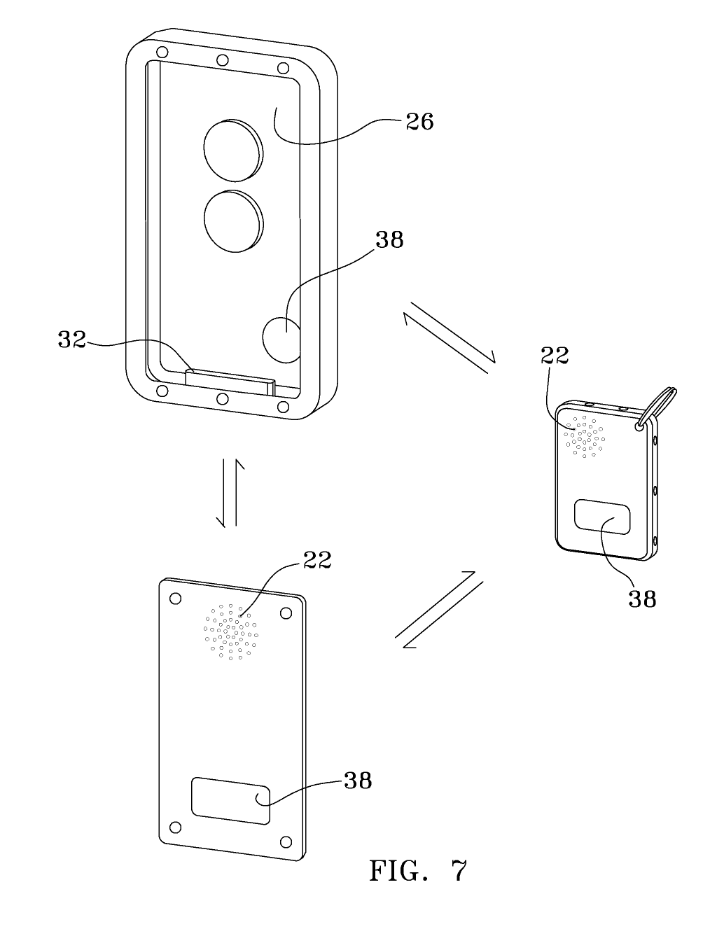

Looking at FIG. 6 the physical layout and internal components of the alert key fob can best be seen.

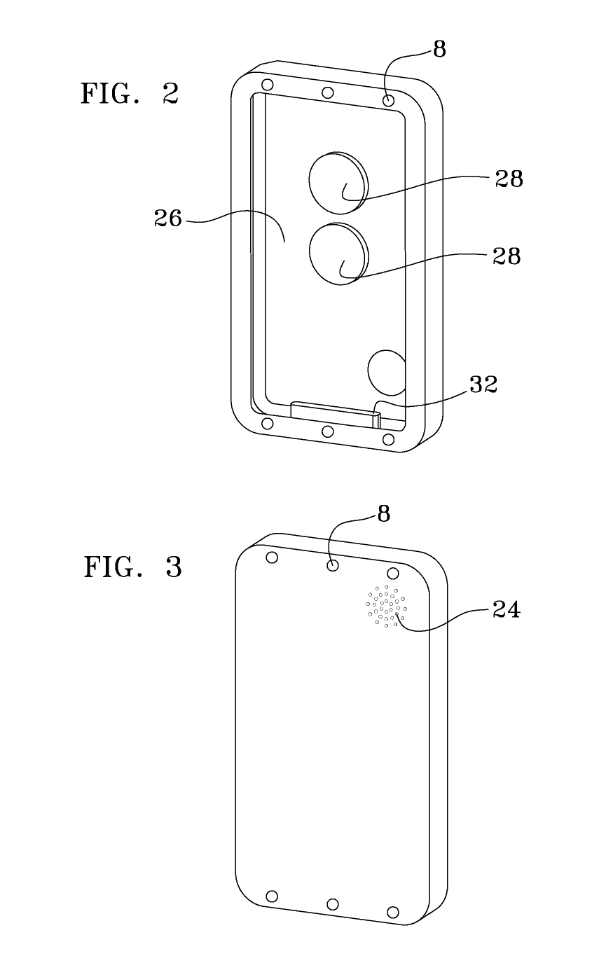

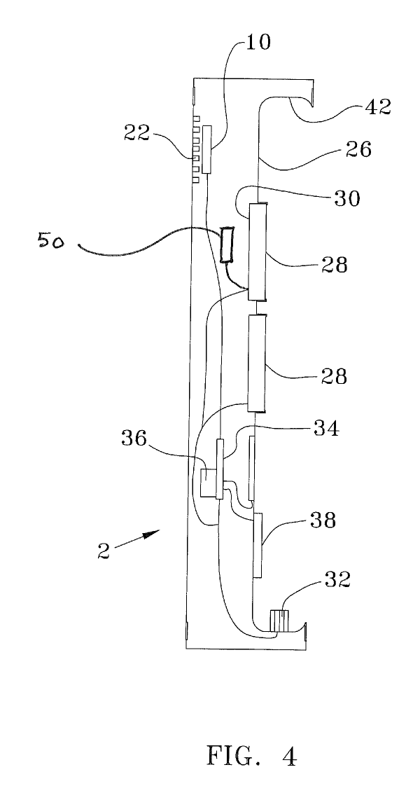

The cell phone alert case 2 besides serving an integral function as the third member of the interactive personal property location system also serves as an emergency cell phone power source. Looking at FIGS. 2 and 4 it can be seen that the cell phone alert case 2 has a male electrical connector 32 that matingly engages the electrical socket of the cell phone. This allows the cell phone to communicate electrical signals or share power with the cell phone alert case 2 through the microprocessor 34. In normal operation the cell phone alert case is powered by the cell phone battery, drawing a small electrical current through the cell phone's electrical socket. In the cell phone alert case 2 on the inner face 26 are detents 30 that house two thin profile batteries 28. (While this is the configuration used to constrain the batteries 28 in the preferred embodiment, there are a plethora of other configurations to physically constrain the batteries 28 that are well known in the art. These batteries in the preferred embodiment are Lithium coin batteries selected for their ability to hold a charge for years. This is important as it is expected that these batteries will not be changed before the owner gets a new cell phone and cell phone case. The batteries 28 have a non conductive disk (not illustrated) placed between one of the battery terminals and the battery terminal contacts of the cell phone alert case 2 to prevent discharge of the battery 28 before desired. To allow a flow of current from either battery 28 the battery 28 must be removed from the detent, the disk removed and the battery 28 replaced in the detent 30. Thus either battery should always be available for emergency activation of the cell phone. In the preferred embodiment this disk would be polymer.

Although illustrated with LEDS 8 about the periphery of the front and back faces of the cell phone case 2 these could be located in a plethora of locations. The preferred embodiment of the body 40 of the cell phone alert case 2 is made of a flexible, slightly compressive polymer. This acts to protect the cell phone by absorbing shock and it also allows the case 2 to flex when inserting the cell phone alert case's male electrical connector 32 into the electrical socket of the cell phone. The body 40 is sized to tightly cradle the cell phone about its sides, thereby keeping the electrical connection between the phone and the case always engaged. The inner side walls of the body 40 have a concave profile to wrap over the sides of the cell phone 44 and onto the cell phone's face. The alert button 38 is located on the inner face 26 and thus requires substantial force on the back of the cell phone case 2 to activate the button. This is done to prevent unwanted activation of the alert system by the cell phone. If the phone is removed from the case 2 the LI coin batteries must be engaged to operated the alert system as the connection to the cell phone battery will be lost. Although this is the preferred embodiment, it is known that there are various blocking means that can be utilized to ensure the battery is not enabled until the blocking means is removed.

Although discussed using LI coin batteries and a non conductive disk, it is also known in the art that a rechargeable DC power source could be used wherein the battery of the cell phone itself acts to ensure a trickle electrical charge is fed to the power source. This type of application is well suited for the new generation of “batteries in a chip” technology.

In operation, (FIG. 7) each of the alert component transponders are set to a common frequency such that activation by depression of any of the alert buttons 38 sends a wireless alert signal that is received by the alert transponders in the other alert components therein enabling the activation of their audible vibrator means and their LEDS. The microprocessor 34 in each alert system regulates the flashing of the LEDS as well as the operation of the component's auditory and vibratory means 10. A second activation of any of the alert buttons 38 sends a second wireless signal that cancels the first signal therein stopping the audible, vibratory and visual alerts and readying each of the alert components for another alert signal.

In operation, in an emergency situation, if battery power is lost the phone can be removed from the cell phone alert case 2, the battery 28 removed, the disk removed, the battery 28 replaced and the phone reinserted into the cell phone alert case 2, ensuring that the electrical connector 32 firmly engages the cell phone electrical socket. Failing to complete the emergency call, or upon negotiating a later time to power up the phone, the process can be repeated with the second battery.

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Having thus described the invention, what is claimed as new and desired to be secured by Letters Patent is as follows:

1. A personal property retrieval system comprising:
an alert key fob component having a first vibratory alert means, a first auditory alert means and a first visual alert means;
an alert credit card component having a second vibratory alert means, a second auditory alert means and a second visual alert means; and
an alert cell phone case component having a third vibratory alert means, a third auditory alert means and a third visual alert means;
wherein said components are in wireless signal communication with each other so as to be able to wirelessly enable or disable said vibratory alert means, said auditory alert means and said visual alert means located on said other components.

2. The personal property retrieval system of claim 1 wherein said alert key fob component further comprises:
a first DC power source;
a first microprocessor;
a first transponder operatively coupled to said microprocessor;
a first alert button; and
a first electrical pathway connecting said first DC power source to said first alert button, said first alert button to said first microprocessor and said first microprocessor to said first vibratory alert means, said first auditory alert means and said first visual alert means.

3. The personal property retrieval system of claim 1 wherein said alert credit card component further comprises:
a second DC power source;
a second microprocessor;
a second transponder operatively coupled to said second microprocessor;
a second alert button; and
a second electrical pathway connecting said second DC power source to said second alert button, said second alert button to said second microprocessor and said second microprocessor to said second vibratory alert means, said second auditory alert means and said second visual alert means.

4. The personal property retrieval system of claim 1 wherein said alert cell phone case component further comprises:
a third DC power source;
a third microprocessor;
a third transponder operatively coupled to said third microprocessor;
a third alert button; and
a third electrical pathway connecting said third DC power source to said third alert button, said third alert button to said third microprocessor and said third microprocessor to said third vibratory alert means, said third auditory alert means and said third visual alert means.

5. The personal property retrieval system of claim 2 wherein said alert cell phone case component further comprises:
a cell phone jack matingly conformed for physical and electrical connection to a cell phone socket;
a third microprocessor;
a third transponder operatively coupled to said third microprocessor;
a third alert button; and
a third electrical pathway connecting said cell phone jack to said third alert button, said third alert button to said third microprocessor and said third microprocessor to said third vibratory alert means, said third auditory alert means and said third visual alert means.

6. The personal property retrieval system of claim 5 wherein said first, second and third visual alert means comprises at least one light emitting diode.

7. The personal property retrieval system of claim 6 wherein said alert cell phone case component further comprises:
a body having four contiguous concave sides and a generally planar back plate;
at least one third DC power source;
at least one detent formed in said back plate matingly conformed to house said third DC power source;
a fourth electrical pathway connecting said third DC power source to said cell phone jack.

8. The personal property retrieval system of claim 7 wherein the number of said third DC power sources and detents is two.

9. The personal property retrieval system of claim 7 further comprising a blocking means preventing electrical connection between said third DC power source and said cell phone jack.

10. The personal property retrieval system of claim 7 wherein said DC power sources are Lithium coin batteries.

11. The personal property retrieval system of claim 2 further comprising a RFID chip also connected to said first electrical pathway.

12. The personal property retrieval system of claim 3 further comprising a RFID chip also connected to said second electrical pathway.

13. The personal property retrieval system of claim 4 further comprising a RFID chip also connected to said third electrical pathway.
